(19) United States
(12) Patent Application Publication
(10) Pub. No.: US 2015/0240114 A1
(43) Pub. Date: Aug. 27, 2015

(54) COATING COMPOSITIONS HAVING ACETOACETOXY-FUNCTIONAL EPOXY-POLYESTER COPOLYMERS

(71) Applicant: THE SHERWIN-WILLIAMS COMPANY, CLEVELAND, OH (US)

(72) Inventors: HONG DING, HUDSON, OH (US); ZHIQI YANG, SOLON, OH (US)

(73) Assignee: THE SHERWIN-WILLIAMS COMPANY, CLEVELAND, OH (US)

(21) Appl. No.: 14/710,680

(22) Filed: May 13, 2015

Related U.S. Application Data
(63) Continuation of application No. 13/832,562, filed on Mar. 15, 2013.

(51) Int. Cl. C09D 163/00; C09D 167/02; C09D 133/00; C09D 167/04; C09D 167/00

(52) U.S. Cl. CPC C09D 163/00; C09D 167/04; C09D 167/00; C09D 133/00; C09D 167/02

(57) ABSTRACT

A multi-component curable composition which is reactive upon admixing of the components and which is the reaction product of: (i) a polyester epoxy block or graft copolymer having acetoacetoxy functionality; and (ii) a crosslinking component. The crosslinking component may include at least one imine functional compound having an average of at least two imine groups per molecule which are reactive with acetoacetoxy functionality.

### PRIORITY CLAIM

This application is a continuation of co-pending U.S. application Ser. No. 13/832,562 filed Mar. 15, 2013. The entirety of this application is hereby incorporated by reference.

### FIELD OF THE INVENTION

The present invention generally relates to curable coating compositions suitable for use over metal substrates and to flexible, ambient cure coatings for metal substrates.

### DETAILED DESCRIPTION OF THE INVENTION

According to one embodiment of the present invention a curable composition comprises:
(a) a polyester epoxy block or graft copolymer having acetoacetoxy functionality; and
(b) a crosslinking component.

Acetoacetoxy functional polymers may be being obtained by partially or completely reacting a mono or polyepoxide with a carboxylic acid functional polycaprolactone polyester polyol to form a hydroxyl functional epoxy-polyester block copolymer, with subsequent reaction of hydroxyl groups on the epoxy-polyester adduct with one or more acetoacetic acid derivatives. The reaction with the acetoacetic acid derivatives is carried out as an esterification or transesterification reaction or as ring opening reaction with diketene.

According to another embodiment of the invention, the polymer containing acetoacetate groups may be a block copolymer comprising polyester and epoxy blocks and having one or more functionalities selected from epoxy and hydroxyl functionalities.

The crosslinking component may comprise an isocyanate crosslinker.

In another embodiment, the crosslinking component may comprise at least one imine functional compound having an average of at least two imine groups per molecule which are reactive with acetoacetoxy functionality.

The curable compositions described herein are particularly suited for use in the preparation of paints and coatings for a variety of substrates, and are particularly suited for metal substrates, and more particularly, for aluminum substrates, including both chrome and non-chrome treated pretreated aluminum substrates.

Examples of suitable epoxy compounds which may be employed in preparation of the hydroxyl functional epoxy-polyester copolymer may include monoepoxides, polyepoxides and blends thereof. Representative useful monoepoxides include the monoglycidyl ethers of aliphatic or aromatic alcohols such as butyl glycidyl ether, octyl glycidyl ether, nonyl glycidyl ether, decyl glycidyl ether, dodecyl glycidyl ether, p-tertbutylphenyl glycidyl ether, o-cresyl glycidyl ether, and 3-glycidoxypropyl trimethoxysilane. Monoepoxy esters such as the glycidyl ester of versatic acid (commercially available as CARDURA® from Momentive) or the glycidyl esters of other acids such as tertiary-nonanoic acid, tertiary-decanoic acid, tertiary-undecanoic acid, etc. are also useful. Similarly, if desired, unsaturated monoepoxy esters such as glycidyl acrylate, glycidyl methacrylate or glycidyl laurate could be used. Additionally, monoepoxidized oils can also be used.

Other useful monoepoxies include styrene oxide, cyclohexene oxide, 1,2-butene oxide, 2,3-butene oxide, 1,2-pentene oxide, 1,2-heptene oxide, 1,2-octene oxide, 1,2-nonene oxide, 1,2-decene oxide, and the like.

Useful polyepoxides may include polyepoxy-functional novalac, bisphenol and cycloalphatic epoxies. Exemplary polyepoxides may have a number average molecular weight less than about 2,000. Polyepoxides may include the di- or polyglycidyl ethers of (cyclo)aliphatic or aromatic hydroxy compounds, such as ethylene glycol, glycerol or cyclohexanediol (or the epoxides as mentioned in the introduction), or cycloaliphatic epoxy compounds such as epoxidized styrene or divinylbenzene which may subsequently be hydrogenated; glycidyl esters of fatty acids, containing for example from 6-24 carbon atoms; glycidyl (meth)acrylate; epoxy compounds containing an isocyanurate group; an epoxidized polyalkadiene such as, for example, epoxidized polybutadiene; hydantoin epoxy resins; epoxy resins obtained by epoxidation of aliphatic and/or cycloaliphatic alkenes, such as, for example, dipentene dioxide, dicyclopentadiene dioxide and vinylcyclohexene dioxide, and resins containing glycidyl groups, for example polyesters or polyurethanes containing one or more glycidyl groups per molecule, or mixtures of the abovementioned epoxy resins. The epoxy resins are known to those skilled in the art and require no further description here.

Difunctional bisphenol A/epichlorohydrin derived polyepoxides (commercially available as EPON® from Momentive) are particularly useful.

Other suitable epoxide compounds may include polyglycidyl ethers based on polyhydric, preferably dihydric, alcohols, phenols, hydrogenation products of these phenols and/or novolacs (reaction products of mono- or polyhydric phenols with aldehydes, in particular formaldehyde, in the presence of acidic catalysts). The epoxide equivalent weights of these epoxide compounds (epoxy resins) are between 100 and 5000, preferably between 160 and 4000. Examples of polyhydric phenols are: resorcinol, hydroquinone, 2,2-bis(4-hydroxyphenyl)propane (bisphenol A), isomer mixtures of dihydroxydiphenylmethane (bisphenol-F), tetrabromobisphenol A, 4,4′-dihydroxydiphenylcyclohexane, 4,4′-dihydroxy-3,3′-dimethyldiphenylpropane, 4,4′-dihydroxybiphenyl, 4,4′-dihydroxybenzophenone, 1,1-bis(4-hydroxyphenyl)ethane, 1,1-bis(4hydroxyphenyl)isobutane, 2,2-bis(4-hydroxy-tert-butylphenyl)propane, bis(2-hydroxynaphthyl)methane, 1,5dihydroxynaphthalene, tris(4-hydroxyphenyl)methane, bis(4-hydroxyphenyl) ether, bis(4-hydroxyphenyl) sulfone etc. and the products of chlorination and bromination of the abovementioned compounds. Bisphenol A and bisphenol F are particularly preferred in this respect.

Also suitable are the polyglycidyl ethers of polyhydric alcohols. Examples of such polyhydric alcohols are ethylene glycol, diethylene glycol, triethylene glycol, 1,2-propylene glycol, polyoxypropylene glycols (n=1-10), 1,3-propylene glycol, 1,4-butylene glycol, 1,5-pentanediol, 1,6-hexanediol, 1,2,6-hexanetriol, glycerol and 2,2-bis(4-hydroxycyclohexyl)propane.

Polyglycidyl esters of polycarboxylic acids can also be used, which are obtained by reacting epichlorohydrin or similar epoxy compounds with an aliphatic, cycloaliphatic or aromatic polycarboxylic acid, such as oxalic acid, succinic acid, adipic acid, glutaric acid, phthalic acid, terephthalic acid, hexahydrophthalic acid, 2,6-napthalenedicarboxylic acid and dimerized linolenic acid. Examples are diglycidyl adipate, diglycidyl phthalate and diglycidyl hexahydrophthalate.

These polyepoxide compounds can also be used in mixtures with one another and, if appropriate, in mixtures with monoepoxides. Examples of suitable monoepoxides are: epoxidized monounsaturated hydrocarbons (butylene oxide, cyclohexene oxide, styrene oxide), epoxide ethers of monohydric phenols (phenol, cresol and other o- or p-substituted phenols), and glycidyl esters of saturated and unsaturated carboxylic acids.

Further suitable epoxides for the reaction may include those containing amide or urethane groups, for example triglycidyl isocyanurate or glycidyl-blocked hexamethylene diisocyanate.

Further suitable epoxide compounds may be derived from unsaturated fatty acids, for example from linoleic acids or linolenic acids. Examples of suitable epoxidized fatty acid derivatives are those from linseed oil, soya bean oil, alkyl esters of ricinene fatty acid, soya bean oil or linoleic fatty acid, oleic or arachidonic acid, and oligomeric fatty acids and their esters, and epoxidized alkyl esters having two or more ester groups are also suitable. Epoxidized linseed oil and soya bean oil are preferred.

Plasticized epoxy resins with terminal epoxy groups are particularly preferred, which are prepared by partial reaction of the epoxy groups of epoxy resins containing at least two epoxy groups with OH- and COOH-containing substances, such as polyhydric alcohols, for example the abovementioned diols or phenols, polycarboxylic acids or polyesters containing carboxyl or OH groups, or by reaction with polyamines.

Possible epoxides containing hydroxyl groups, within the meaning of the present invention, are also reaction products of compounds having at least two 1,2-epoxide groups per molecule and epoxide equivalent weights of from 160 to 600, and aromatic dicarboxylic acids or mixtures thereof with compounds from the group comprising (cyclo)aliphatic dicarboxylic acids, monocarboxylic acids and/or monohydric phenols, and optionally cyclic anhydrides. Products of this type are described in EP-0 387 692, to which reference is made here. For the preparation of these reaction products it is possible to use all the epoxy compounds mentioned in the introduction.

According to one embodiment of the present invention, an epoxy-polyester copolymer containing acetoacetate functionality may be obtained by partially or completely reacting the epoxy groups of a mono or polyepoxide (as described above) with a carboxylic acid functional polycaprolactone polyester polyol, with subsequent reaction of this reaction product with one or more acetoacetic acid derivatives.

Acid functional polyesters polyols, which may be useful in the present invention, may be made by the lactone or polycaprolactone ring opening polymerization initiated by hydroxy-functional acid. In general such polyesters will also have a terminal hydroxyl group or groups.

For example, the ring opening polymerization of caprolactone initiated by 2-2′-bis(hydroxymethyl) propionic acid (also referred to as dimethylol propionic acid or DMPA) provides a useful way to make a monoacid functional polyester. Another useful reaction is between dimethylolbutyric acid and caprolactone to form a carboxyl modified polycaprolactone, in particular a polycaprolactone polyester diol with a pendant carboxylic functional group. Other hydroxy-functional carboxylic acids and lactones may also be used to form useful acid functional polyesters. Without being limited to any particular theory, the extent of caprolactone modification believed to be most useful is by having a resulting number average molecular weight measured by gel permeation chromatography using polystyrene as a standard (“GPC”) of over about 500, for example, about 500 to about 4000. The use of these polyesters has the advantage of providing hydroxyl groups on the side chains for subsequent reaction with acetoacetic acid derivatives. Examples of commercially available acid functional polycaprolactone polyester diols include CAPA polyester diols available from Perstorp and DICAP polyester diols available from GEO Specialty Chemicals. Polyesters of caprolactone using 2-ethylhexanol as the initiating alcohol and dibutyl tin dilaurate as the catalyst reacted with a cyclic anhydride to form a terminal acid group may also be useful in the present invention.

In another useful embodiment, an acid functional polycaprolactone polyester diol may be modified by capping one or both hydroxyl groups using one or more mono-functional acids, R—COOH. In one useful embodiment, R may have about 4 to about 18, for example, about 11 to about 12 carbon atoms. Examples of useful mono-functional carboxylic acids include lauric acid, caprylic acid, capric acid, myristic acid, palmitic acid, stearic acid, oleic acid, elaidic acid (9-octadecenoic acid), linoleic acid, linolenic acid, stealoric acid, soya fatty acid or other fatty acids. In one useful embodiment, two moles of such a mono-functional acid may react with the hydroxyl groups of the polyester to form a mono-acid functional polyester, where both hydroxyl groups are capped by the ester chains.

By controlling the molar ratios of acid groups on the polyester to epoxy groups in the reaction mixture, the product of the epoxide and the acid functional polycaprolactone polyester polyol reaction described above may include epoxy functionality and/or primary and secondary hydroxyl functionality. Accordingly, in one embodiment, a useful epoxy-polyester block copolymer may be formed as a reaction product of the aforementioned components having an acid/epoxy molar ratio of 0.8 to about 1.1, and in anther embodiment, of about 1.8 to about 2.1.

In one useful embodiment, the reaction product may be a polyester epoxy diblock copolymer (adduct) formed as the reaction product of the acid functional polycaprolactone polyester polyol and a monofunctional epoxide or the reaction product of a polyepoxide with an appropriate molar ratio of the acid functional polycaprolactone polyester polyol to ensure unreacted epoxy groups. In another useful embodiment, the reaction product may be a polyester epoxy polyester triblock copolymer, formed as the reaction product of a difunctional epoxide with an appropriate molar ratio of the acid functional polycaprolactone polyester polyol to ensure opening of substantially all of the epoxy groups. In either case, the reaction product will preferably have free hydroxyl groups, contributed by the polyester polyol or resulting from the epoxide ring opening, which may be subsequently reacted directly with acetoacetic acid derivatives. While the present invention characterizes the reaction product of the acid functional polyester and epoxy as a block co-polymer, it will be recognized that the reaction product, in some embodiments, may be characterized as polyester grafted epoxy copolymer, particularly in embodiments comprising acid functional polyesters and bisphenol F-type epoxies.

The subsequent esterification of the hydroxyl groups of the epoxide-polyester adduct to give acetoacetates is carried out as a rule by reaction with monomeric acetoacetic acid esters such as, for example, methyl, ethyl or tert-butyl acetoacetate. The degree of esterification of the hydroxyl groups can be varied here over a wide range, depending on the properties desired in the end product.

The transesterification is carried out by heating both components together at boiling and slowly, if appropriate under vacuum, distilling off the lower-boiling alcohol which is formed.

However, the esterification of the hydroxyl groups can also be carried out with equivalents of acetoacetic acid, such as for example, diketene or 2,2,6-trimethyl-1,3-dioxan-4-one.

By selection, particularly of the molar ratios of reaction components, the product of the acetoacetate acid derivative and the epoxide-polyester adduct may include acetoacetoxy functionality in addition to one or more of epoxy functionality and primary and secondary hydroxyl functionality.

Crosslinkers

Isocyanates

Provided there are free hydroxyl groups on the acetoacetoxy functionalized epoxy-polyester copolymers, the acetoacetoxy functionalized epoxy-polyester copolymers described above may be crosslinked using a suitable isocyanate crosslinker. The hydroxyls may be primary or secondary.

Polyisocyanates useful for reaction with the acetoacetoxy functionalized copolymers according to the preferred configuration have an average of at least two isocyanate groups per molecule. Representative polyisocyanates include the aliphatic compounds such as ethylene, trimethylene, tetramethylene, pentamethylene, hexamethylene, 1,2-propylene, 1,2-butylene, 2,3-butylene, 1,3-butylene, ethylidene and 1,2-butylidene diisocyanates; the cycloalkylene compounds such as 3-isocyanatomethyl-3,5,5-trimethylcyclohexylisocyanate, and the 1,3-cyclopentane, 1,3-cyclohexane, and 1,2-cyclohexane diisocyanates; the aromatic compounds such as m-phenylene, p-phenylene, 4,4-diphenyl, 1,5-naphthalene and 1,4-naphthalene diisocyanates; the aliphatic-aromatic compounds such as 4,4-diphenylene methane, 2,4- or 2,6-toluene or mixtures thereof, 4,4′-toluidine, and 1,4-xylylene diisocyanates; the nuclear substituted aromatic compounds such as dianisdine diisocyanate, 4,4′-diphenylether diisocyanate and chlorodiphenylene diisocyanate; the triisocyanates such as triphenyl methane-4,4′,4″-triisocyanate toluene; and the tetraisocyanates such as 4,4′-diphenyl-dimethyl methane-2,2′,5,5′-tetraisocyanate; the polymerized polyisocyanates such as dimers and trimers, and other various polyisocyanates containing biuret, urethane, and/or allophanate linkages.

Imine Compounds

In another embodiment, the acetoacetoxy functionalized epoxy-polyester copolymers may be crosslinked by means of a crosslinking component comprising at least one imine functional compound having an average of at least two imine groups per molecule which are reactive with acetoacetoxy functionality.

The imine compounds which are useful in the present invention may be generally represented by the formula:

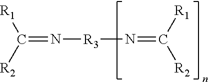

wherein n is 1 to 30, and preferably n is 1 to 5; R₁ and R₂ are hydrogen, an alkyl, aryl, cycloaliphatic, or substituted alkyl, aryl, or cycloaliphatic group; and R₁ and R₂ may be the same or different; and R₃ is an aliphatic, aromatic, arylaliphatic or cycloaliphatic group which may also contain heteroatoms such as O, N, S, or Si.

These imine compounds are typically prepared by the reaction of certain carbonyl compounds such as aldehydes and ketones with amines. Representative carbonyl compounds which may be used to form the imine include ketones such as acetone, methyl ethyl ketone, methyl isopropyl ketone, methyl isobutyl ketone, diethyl ketone, benzyl methylketone, diisopropyl ketone, cyclopentanone, and cyclohexanone, and aldehydes such as acetaldehyde, formaldehyde, propionaldehyde, isobutyraldehyde, n-butyraldehyde, heptaldehyde and cyclohexyl aldehydes. Representative amines which may be used to form the imine include ethylene diamine, ethylene triamine, propylene diamine, tetramethylene diamine, 1,6-hexamethylene diamine, bis(6-aminohexyl)ether, tricyclodecane diamine, N,N′-dimethyldiethyltriamine, cyclohexyl-1,2,4-triamine, cyclohexyl-1,2,4,5-tetraamine, 3,4,5-triaminopyran, 3,4-diaminofuran, and cycloaliphatic diamines such as those having the following structures:

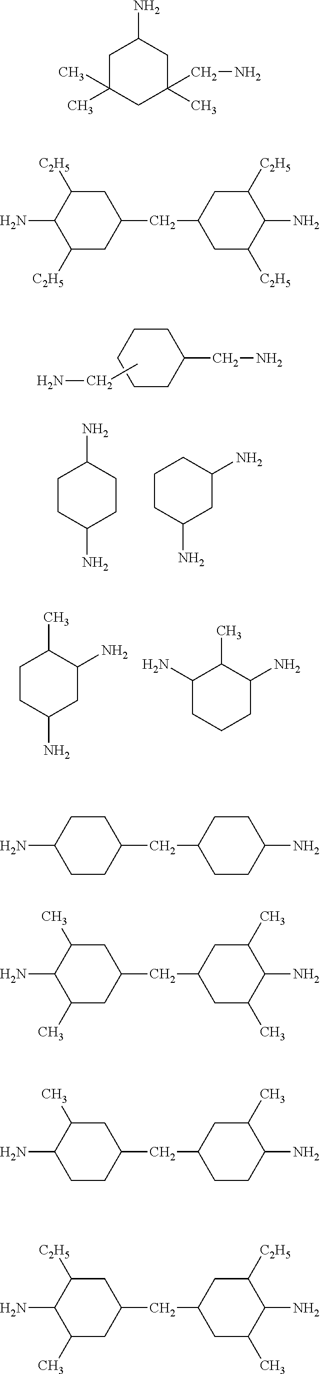

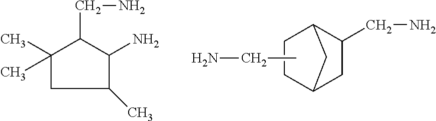

The imines are conveniently prepared by reacting a stoichiometric excess of the ketone or aldehyde with the polyamine in an azeotropic solvent and removing water as it is formed. In order to minimize side reactions, and to avoid delays due to prolonged processing, it is frequently desirable to avoid the prolonged heating necessary to remove all of the excess ketone or aldehyde and unreacted starting materials, provided that their presence does not adversely affect the performance of the final product.

One preferred type of imine compound for reaction with acetoacetoxy functional materials in the practice of this invention is an adduct obtained by reacting an imine having an additional reactive group other than an imine, such as a hydroxyl group or, preferably, an amine group with a compound, such as an isocyanate, or an epoxide, having one or more chemical groups or sites capable of reaction with the additional reactive group. For example, an imine obtained from the reaction of two moles of an aldehyde or ketone with a triamine having two primary and one secondary amine groups, such as diethylene triamine, will have an unreacted secondary amine group which could be subsequently reacted with a mono and/or polyepoxide, or a mono or polyisocyanate to produce the imine functional adduct. One especially preferred commercial imine having an additional reactive group is Shell Epicure 3501 and KT22 from Air Products which is the reaction product of diethylene triamine and methyl isobutyl ketone.

Polyisocyanates useful for reaction with the hydroxyl or amine group of the imine in the preferred configuration may include those identified as crosslinkers above.

For reaction with the imines having unreacted amine groups, representative useful monoepoxides include many of those cited above, such as the monoglycidyl ethers of aliphatic or aromatic alcohols such as butyl glycidyl ether, octyl glycidyl ether, nonyl glycidyl ether, decyl glycidyl ether, dodecyl glycidyl ether, p-tertbutylphenyl glycidyl ether, o-cresyl glycidyl ether, and 3-glycidoxypropyl trimethoxysilane. Monoepoxy esters such as the glycidyl ester of versatic acid (commercially available as CARDURA® from Momentive, or the glycidyl esters of other acids such as tertiary-nonanoic acid, tertiary-decanoic acid, tertiary-undecanoic acid, etc. are also useful. Similarly, if desired, unsaturated monoepoxy esters such as glycidyl acrylate, glycidyl methacrylate or glycidyl laurate could be used. Additionally, monoepoxidized oils can also be used.

Other useful monoepoxies include styrene oxide, cyclohexene oxide, 1,2-butene oxide, 2,3-butene oxide, 1,2-pentene oxide, 1,2-heptene oxide, 1,2-octene oxide, 1,2-nonene oxide, 1,2-decene oxide, and the like.

Especially preferred as the poly-functional epoxy compounds, due to their reactivity and durability, are the polyepoxy-functional novalac, bisphenol and cycloalphatic epoxies. Preferably, the polyepoxies will have a number average molecular weight less than about 2,000 to minimize the viscosity of the adduct. It is particularly preferred for some applications to utilize a combination of both an imine adduct prepared by reaction of an imine having a secondary amine group and a polyepoxide and an imine adduct obtained by reaction of an imine having a secondary amine group and a monoepoxide.

The curable coating compositions according to the invention may optionally contain a diluent, such as conventional inert organic solvents. Examples are: halogenated hydrocarbons, ethers, such as, diethyl ether, 1,2-dimethoxyethane, tetrahydrofuran or dioxane; ketones, such as, for example, methyl ethyl ketone, acetone, cyclohexanone and the like; alcohols, such as methanol, ethanol, propanol, methoxypropanol, butanol and benzyl alcohol, (cyclo)aliphatic and/or aromatic solvents in the boiling range from about 150° to 180° C. or esters, such as butyl acetate. The solvents can be employed individually or in a mixture.

Conventional additives which may be present in the coating compositions according to the invention are—depending on the particular intended use—the conventional coating additives such as pigments, pigment pastes, antioxidants, leveling and thickening agents, flow assistants, antifoams and/or wetting agents, fillers, catalysts, additional curing agents and additional curable compounds, etc. These additives can if appropriate be added to the mixture only immediately prior to processing.

One useful pigment package comprises at least one metal phosphate compound, such as Zn, Al, Ca, Fe, preferably aluminum polyphosphate modified by a metal compound, including but not limited to calcium, strontium, zinc, or manganese, or at least one metal compound modified polyphosphate combined with an ion exchanged inorganic pigment, such as calcium ion exchanged silica.

In one useful embodiment, the present invention may comprise about 5 to about 80 parts by weight, for example about 15 to about 40 parts by weight of polymeric binder, and about 2 to about 36 parts by weight, for example about 6 to about 20 parts by weight of metal modified aluminum polyphosphate pigment. The remainder of the coating composition may comprise components generally known to those of ordinary skill in the art. The coating may optionally include about 0.1 to about 20 parts by weight, for example, about 0.5 to about 15 parts by weight of one or more ion exchanged inorganic pigments.

Various metal modified aluminum polyphosphates are commercially available such as zinc aluminum phosphate sold by Tayca as K-WHITE® 105 and K-WHITE® 108 or by SNCZ as NOVINOX™ PAZ. Strontium aluminum polyphosphate is also available from Huebach as HUECOPHAS™ SRPP and SAPP, or from SNCZ as NOVINOX™ PAS. Manganese aluminum polyphosphate is also available from SNCZ as NOVINOX™ PAM. Ion exchanged in organic pigments are available from WR Grace under the tradename SHIELDEX® AC5 or AC3, which is a cation exchanged calcium ion exchanged silica. An example of an anion exchanged inorganic pigment is HALOX® 430, available from Halox.

A preferred area of application for the acetoacetoxy functionalized epoxy-polyester copolymers according to the invention is in coating preparations. In this respect, coatings comprising the acetoacetoxy functionalized epoxy-polyester copolymers and a crosslinker as described above are useful. It is noted however that coatings comprising resin blends comprising the acetoacetoxy functionalized epoxy-polyester copolymers described herein with one or more other acetoacetoxy functionalized polymers, including without limitation acetoacetoxy functionalized acrylics, epoxies, alkyds, and polyesters may be useful.

Compositions according to the invention can be used in the production of final and/or intermediate coatings on a wide variety of substrates, for example on those of organic or inorganic nature, such as, for example, wood, textiles, plastics, glass, ceramics or building materials, but in particular on metal, and more particularly Alodine 1200 and 1000-chrome pretreated aluminum and non-chrome pretreatment aluminum. Furthermore the mixtures according to the invention can be employed as constituents of paints and coatings for coating industrial articles and domestic appliances, such as, for example, refrigerators, washing machines, electrical devices, windows and doors. Application can be carried out by, for example, brushing, spraying, dipping etc.

The coatings obtained are notable for improved flexibility.

### EXAMPLES

The invention is described further by the following example, which is intended to be illustrative and by no means limiting.

### Preparation of AcAc Functional Polyester Epoxy Resins

### Example 1

To a four-necked reactor equipped with an overhead stirrer, temperature controller, horizontal condenser and nitrogen inlet, 130.6 grams of a carboxylic acid functional polyester polycaprolactone polyol (Dicap 1000), 326.5 grams of a monofunctional epoxide (Cardura E10), 146.5 grams dimethylolpropionic Acid (DMPA) and 0.70 grams n-methylimidazole were charged. The mixture was heat to 135° C. under nitrogen and was held for 4 hours at which the acid value reached 0.34 mg KOH/g solid. The reactor was cooled to 100° C. 396.5 grams of tertiary butyl acetoacetate and 0.70 grams of tertiary butyl stannoic acid were then added to the reactor. The reaction temperature was gradually increased to 145° C. while collecting distillate. The mixture was cooled and 175.0 grams methylamyl ketone was added before the solution was discharged. The resulting resin had an NVM of 80.5%, a weight per gallon of 8.69 lb/gal, a Gardener-Holdt viscosity of C, a number average molecular weight of 796, and a weight average molecular weight of 1191.

### Example 2

To a four-necked reactor equipped with an overhead stirrer, temperature controller, horizontal condenser and nitrogen inlet, Dicap 1000 (104.0 grams), 413.5 grams of a difunctional epoxide (Epon 828), DMPA (116.7 grams) and n-methylimidazole (0.67 grams) were charged. The mixture was heat to 135° C. under nitrogen and was held until the acid value reached 2.8 mg KOH/g solid. The reactor was cooled to 100° C. Tertiary butyl acetoacetate (315.8 grams) and tertiary butyl stannoic acid (0.67 grams) were then added to the reactor. The reaction temperature was gradually increased to 135° C. while collecting distillate. The mixture was cooled and methylamyl ketone (166.30 grams) was added before the solution was discharged. The resulting resin had an NVM of 78.5%, a weight per gallon of 9.12 lb/gal, a Gardener-Holdt viscosity of U, a number average molecular weight of 1650, and a weight average molecular weight of 1980.

### Preparation of Paint Formulations

### Example 3

### Preparation of Mill Base

A mixture of 105.27 grams of the resin from Example 1, 39.71 grams of a dispersing agent (DisperByk 103 available from BYK), 8.20 grams of an epoxy silane (from Dow Corning), 21.06 grams propylene glycol methyl ether acetate and 37.91 grams n-butyl acetate were mixed for 15 minutes. 3.25 grams carbon black, 98.24 grams talc, 77.58 grams Kaolin clay, 120.20 grams titanium oxide and 230.30 grams Barium Sulfate were sifted into the mixture and grind to 7 Hegman grind. 20.90 grams MAK, 100.00 grams Epon 1001-B-80 and 16.52 grams acetone were then added.

Admixture with Hardener and Reducer.

120.00 grams of the above described mill base dispersion was mixed thoroughly with 22.60 grams of a ketone and ester solvent blend (US-3 solvent available from The Sherwin-Williams Company), 14.07 grams proprietary ketimine epoxy adduct crosslinker (NH77 available from The Sherwin-Williams Company) hardener, inducted for 30 minutes. The admixture showed 3 hours pot life. The admixture was sprayed by Devilbiss HVLP gun at 55 psi on clean 2024T3 clad substrate with Alodine 1000 pretreatment.

Results.

After 7 days ambient cure, the coating has the following properties: dry film thickness around 1.0 mil, dry adhesion rated 10 per Boeing BSS7225. Wet adhesion after 7 days water immersion was rated 10 with few blisters per Boeing BSS7225. MEK double rub was 82. Both direct impact and reverse impact rated 60 in-lb. No cracks showed in conical mandrel testing. 3000 hour ASTM B117 salt fog average scribe creepage rated 5 per ASTM D1654 with few No. 8 blisters per ASTM D714. 1000 hour filiform (top coated with SW JetGlo Express CMO 480103) scribe creepage rated 6 per ASTM D1654.

### Example 4

### Preparation of Mill Base

A mixture of 105.27 grams of the resin from Example 1, 39.71 grams DisperByk 103, 8.20 grams epoxy silane, 21.06 grams propylene glycol methyl ether acetate and 37.91 grams n-butyl acetate were mixed for 15 minutes. 1.98 grams carbon black, 98.07 grams K-White 108, 53.76 grams Shieldex AC-5, 59.73 grams talc, 47.17 grams Kolin clay, 73.09 grams titanium oxide and 140.03 grams Barium Sulfate were sifted into the mixture and grind to 7 Hegman grind. 20.90 grams MAK, 100.00 grams Epon 1001-B-80 and 16.52 grams acetone were then added.

Admixture with hardener and reducer. 120.00 grams of the above described mill base dispersion was mixed thoroughly with 24.108 grams US-3 solvent, 15.01 grams NH77 hardener, inducted for 30 minutes. The admixture showed 4 hours pot life. The admixture was sprayed by Devilbiss HVLP gun at 55 psi on clean 2024T3 clad substrate with Alodine 1000 pretreatment.

Results.

After 7 days ambient cure, the coating has the following properties: dry film thickness around 1.0 mil, dry adhesion rated 10 per Boeing BSS7225. Wet adhesion after 7 days water immersion was rated 10 per Boeing BSS7225. MEK double rub was 133. Both direct impact and reverse impact rated 60 in-lb. No cracks showed in conical mandrel testing. 3000 hour ASTM B117 salt fog average scribe creepage rated 8 per ASTM D1654 and no blisters. 1000 hour filiform (top coated with SW JetGlo Express CMO 480103) scribe creepage rated 7 per ASTM D1654.

While the invention has been explained in relation to its preferred embodiments, it is to be understood that various modifications thereof will become apparent to those skilled in the art upon reading the specification. Therefore, it is to be understood that the invention disclosed herein is intended to cover such modifications as fall within the scope of the appended claims.

I claim:

1. A coating composition comprising:
A polymeric binder, which is the reaction product of:
(a) an acetoacetoxy functional polyester epoxy block or graft copolymer; and
(b) a crosslinking component.

2. The coating composition of claim 1, wherein the acetoacetoxy functional polyester epoxy copolymer comprises the reaction product of:
(a) an epoxy functional agent, and
(b) an acid functional polycaprolactone polyester polyol.

3. The coating composition of claim 2, wherein the epoxy functional agent is a monoepoxide.

4. The coating composition of claim 2, wherein the epoxy functional agent is a polyepoxide having two or more epoxy functionalities.

5. The coating composition of claim 4, wherein the acetoacetoxy functional polyester epoxy block copolymer is a diblock copolymer.

6. The coating composition of claim 4, wherein the acetoacetoxy functional polyester epoxy block copolymer is a triblock copolymer.

7. The coating composition of claim 4, wherein the acetoacetoxy functional polyester epoxy copolymer is a graft copolymer.

8. The coating composition of claim 1, wherein the crosslinking component is an isocyanate functional crosslinker.

9. The coating composition of claim 1, wherein the crosslinking component comprises at least one imine functional compound having an average of at least two imine groups per molecule which are reactive with acetoacetoxy functionality.

10. The coating composition of claim 8, further comprising at least one other acetoacetoxy functional polymer selected from the group consisting of acetoacetoxy functional acrylics, epoxies, polyesters and alkyds.

11. The coating composition of claim 10, further comprising a metal modified aluminum polyphosphate pigment.

12. A coating composition comprising:
a polymeric binder, which is the reaction product of:
(a) an acetoacetoxy functional polyester epoxy block or graft copolymer having an epoxy functionality and, optionally, an hydroxyl functionality; and
(b) an imine functional crosslinking compound.

13. The coating composition of claim 12, wherein the acetoacetoxy functional polyester epoxy block or graft copolymer comprises hydroxyl functionality and epoxy functionality.

14. The coating composition of claim 12, wherein the imine functional crosslinking compound comprises the reaction adduct of a polyimine having an unreacted functional group selected from hydroxyl and amine functional groups, and a polyisocyanate.

15. The coating composition of claim 14, wherein the imine functional crosslinking compound comprises the reaction adduct of a polyimine having a secondary amine, and a polyisocyanate.

16. The coating composition of claim 12, wherein the imine functional crosslinking compound comprises the reaction adduct of a polyimine having an unreacted functional group selected from hydroxyl and amine functional groups, and a polyepoxide.

17. The coating composition of claim 16, wherein the imine functional crosslinking compound comprises the reaction adduct of a polyimine having an unreacted secondary amine and a polyepoxide.
